(19) United States
(12) Patent Application Publication
(10) Pub. No.: US 2009/0075693 A1
(43) Pub. Date: Mar. 19, 2009

(54) MULTIFUNCTIONAL CRADLE FOR MOBILE COMMUNICATION DEVICE

(76) Inventors: Min Suck So, Seongnam-si (KR); Sang Hun Park, Yongin-si (KR)

Correspondence Address: KANG INTELLECTUAL PROPERTY LAW, LLC, 214 ELM STREET, SUITE 106, WASHINGTON, MO, 63090, US

(21) Appl. No.: 12/209,600

(22) Filed: Sep. 12, 2008

(30) Foreign Application Priority Data
Sep. 18, 2007 (KR) 10-2007-94658

(51) Int. Cl. H04M 1/00

(52) U.S. Cl. 455/556.1

(57) ABSTRACT

A multifunctional cradle for a mobile communication device is equipped and used in a mobile phone store. The cradle includes a base plate having a mounting part provided on the surface thereof to mount and support the mobile communication device; and a display module installed uprightly on the base plate and configured to communicate data with the base plate. The base plate is provided with a communication interface for allowing data communication with a server of a mobile communication device manufacturer or a mobile communication service provider by a wire/wireless communication network; a memory; and a controller for controlling whole operation of the cradle. The controller is adapted to receive predetermined data from the server via the communication interface, to store the predetermined data in the memory and to output the predetermined data via the display module.

### BACKGROUND OF THE INVENTION

1. Field of the Invention

The present invention relates to a cradle for a mobile communication device.

2. Description of the Related Art

As mobile communication environments are rapidly changing, varieties of mobile communication devices have been introduced to users in the market. As the users' needs and wants on the mobile communication devices are diversified, the varieties of communication devices have been provided so as to satisfy every needs and wants in the market day by day.

The user normally visits a showroom or a retail store displaying the mobile communication devices and chooses what he/she wants. In the showroom or the retail store, each mobile communication device is usually mounted on a cradle made of synthetic resin such as plastics together with a printout (normally paper), which shows simplified specifications about the displayed device in order to provide general information to the users.

As mentioned above, rather than supplying the same type of mobile communication device stably, newly developed mobile communication devices are continuously introduced in the market every day, and the showroom or the manufacturer needs to provide new information on the newly introduced devices to the retail store. The retail store should manipulate the provided information in accordance with the stores' own strategy and place the printouts together with the plastic cradle.

Since one mobile communication device can be displayed on one conventional cradle with one printout showing corresponding specifications for new device on the cradle, the inconvenience of printing out and displaying the new information about a newly introduced device needs to be continuously followed whenever a newly developed mobile communication device is provided. Besides, the cradle used in the store plays a simple role of mounting the device without providing any other information about the device.

In the meantime, there are more than thousands of mobile phone stores in South Korea and tens of thousands in the United States, and communication device manufacturers or mobile service providers need to provide detail information on the communication devices together with the printouts whenever newly developed devices are supplied to the mobile phone stores. This will cause increasing expenses with huge manpower and lots of time to the manufacturers or the mobile service providers.

When the user buys a mobile communication device, a charger is normally provided together at the same time. However, the charger works as a simple device only for charging the mobile communication device by mounting the device or using a USB port without any other additional functions.

### SUMMARY OF THE INVENTION

The present invention has been made to solve the foregoing problems with the related art, and an embodiment of the invention provides a multifunctional cradle for a mobile communication device, which can receive specific information on the mobile communication device directly from a manufacturer and display the received information for a user in a mobile communication device retail store without any additional jobs such as printing out the information on a sheet of paper.

Another embodiment of the invention provides a multifunctional cradle for a mobile communication device, which can display directly thereon various kinds of specific information about the mobile communication device mounted on the cradle, related advertisements on the mobile communication device, and related public announcements on the mobile communication device, as well as information about the mobile communication device itself.

A further embodiment of the invention provides a multifunctional cradle for a mobile communication device, which can display information regarding all mobile communication devices selling in a store in regular sequence, so that the consumer can get all the information about various kinds of mobile communication devices from one cradle once the mobile communication device is mounted on the cradle.

Still another embodiment of the invention provides a multifunctional cradle for a mobile communication device, which can directly display information on the mobile communication device, related advertisements on the mobile communication device and the related public announcements on the mobile communication device and also display a specific information that the user wants to get on a separate external display device in order to give strong impact to the other person.

Another embodiment of the invention provides a multifunctional cradle for a mobile communication device, wherein a user can search and display various files that are saved in the mobile communication device and play/display a variety of media files as well as charging the mobile communication device.

Still another embodiment of the invention provides a multifunctional cradle for a mobile communication device, which can facilitate playing computer accessible files and a variety of media files, saved not only in the mobile communication device but also in generally used devices such as a portable storage device and an external AV device, without connecting with a computer.

Yet another embodiment of the invention provides a multifunctional cradle for a mobile communication device, which can facilitate not only using various files and a variety of media files saved in the mobile communication device, a portable storage device and an external AV device but also using immediately the above mentioned files by connecting with an externally separated output device, so that user amusement can be enhanced.

In an exemplary embodiment of the invention, a multifunctional cradle for a mobile communication device is provided and used in a mobile phone store. The cradle may include a base plate having a mounting part provided on a surface thereof to mount and support the mobile communication device; and a display module installed uprightly on the base plate and configured to communicate data with the base plate. The base plate comprises therein a communication interface for allowing data communication with a server of a mobile communication device manufacturer or a mobile communication service provider through a wire/wireless communication network; a memory; and a controller for controlling whole operation of the cradle. The controller is constructed to receive predetermined data from the server via the communication interface, to store the predetermined data in the memory and to output the predetermined data via the display module. The predetermined data may include at least one selected from the group consisting of product information data, advertisement data that the mobile communication device manufacturer or the mobile communication service provider wants to deliver and a variety of multimedia service related data.

In another exemplary embodiment of the invention, a multifunctional cradle for a mobile communication device is provided. The cradle may include a cradle body having a polyhedral structure; a display module provided on one side of the body to display data received from a server of a mobile communication device manufacturer or a mobile communication service provider; and a mounting part provided to a part of the cradle body and having a receiving portion for receiving the mobile communication device. The cradle body is provided therein with a communication interface for allowing data communication with the server through a wire/wireless communication network; a memory; and a controller for controlling whole operation of the cradle. The controller is constructed to receive predetermined data from the server via the communication interface, to store the predetermined data in the memory and to output the predetermined data via the display module. The predetermined data may include at least one selected from the group consisting of product information data, advertisement data that the mobile communication device manufacturer or the mobile communication service provider wants to deliver and a variety of multimedia service related data.

According to the present invention, one mobile communication device provides multiple additional functions in addition to the basic function of mounting the mobile communication device. With the cradle of the present invention, a mobile communication device manufacturer or a mobile service provider can display information data to the user by simply transferring to the mobile phone stores all over the area using the wire/wireless communication environment without any cost exhaustive job of providing the product related information with the printouts.

In addition to the basic functions of mounting the mobile communication device in accordance with the present invention, as described below, the inconvenience of connecting the external devices with the computer can be overcome by one effort since the cradle can be directly connected with the mobile communication device and the external AV device such as USB memory or MP3 players as well as charging the mobile communication device, and a variety of computer files and the media files can be enjoyed by displaying on the display module.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the exterior of a multifunctional cradle for a mobile communication device according to an exemplary embodiment of the present invention;

FIG. 2 is a schematic block diagram illustrating the multifunctional cradle according to an exemplary embodiment of the present invention;

FIG. 3 is a perspective view illustrating a multifunctional cradle for a mobile communication device according to another exemplary embodiment of the present invention;

FIG. 4 is a schematic block diagram illustrating the multifunctional cradle according to another exemplary embodiment of the present invention; and

FIG. 5 is a perspective view illustrating a multifunctional cradle for a mobile communication device according to yet another exemplary embodiment of the present invention.

### DETAILED DESCRIPTION OF THE EXEMPLARY EMBODIMENT

The present invention will now be described more fully hereinafter with reference to the accompanying drawings, in which exemplary embodiments thereof are shown. The ensuing detailed description illustrates exemplary embodiments only, and is not intended to limit the scope, applicability, or configuration of the invention. In the following description, a detailed description of known functions and configurations incorporated herein will be omitted and the configuration of the present invention will be understood without any difficulties by those skilled in the art with the following description with reference to the accompanying drawings.

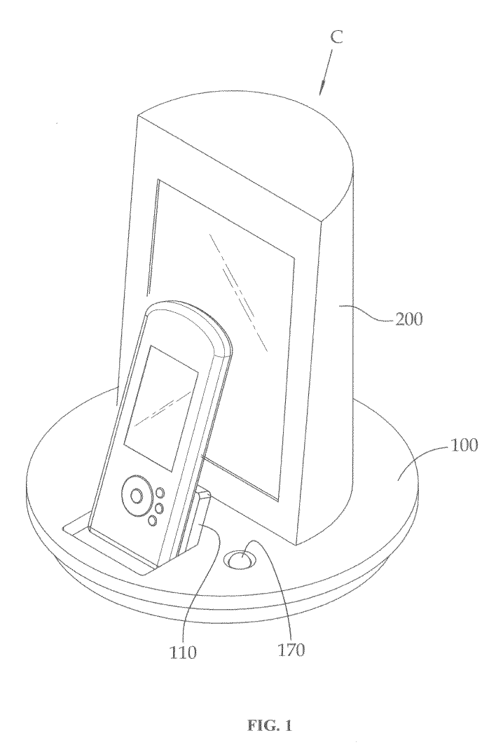

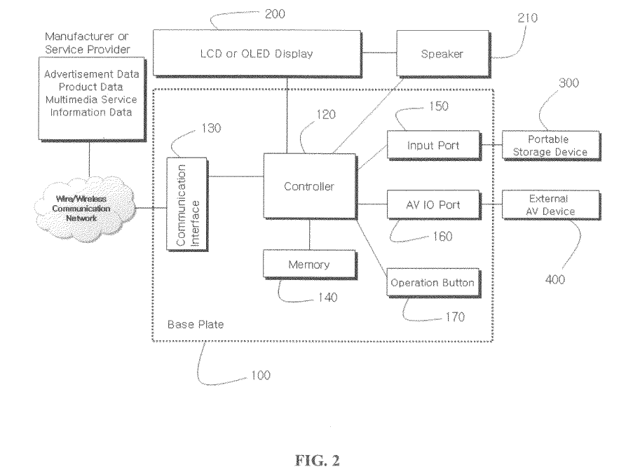

FIG. 1 is a perspective view illustrating a multifunctional cradle for a mobile communication device (hereinafter, referred to as “multifunctional cradle” or “cradle”) C according to an exemplary embodiment of the present invention, and FIG. 2 is a schematic block diagram illustrating the multi functional cradle according to an exemplary embodiment of the present invention.

Referring to FIG. 1 illustrating the overall configuration of the multifunctional cradle C according to the present invention, the cradle C includes a base plate 100 formed on the surface thereof with a mounting part 110 for mounting and supporting the mobile communication device; and a display module 200 installed uprightly (almost perpendicularly) on the base plate 100. The display module 200 is an LCD (Liquid Crystal Display) or an OLED (Organic Light Emitting Device) configured to communicate data with the base plate 100. As easily understood in the drawing, the multifunctional cradle C in accordance with the present invention is mainly for mounting the mobile communication device, is made as a small size, and is configured as freely movable.

The base plate 100 is to mount and support the mobile communication device such as a mobile phone, and the user can display or keep the mobile phone by mounting on the mounting part 110. As described below, the display module 200 is to display the prescribed data received or transferred under control of a controller 120. A variety of media files, such as the photo image files and music files, and all the files saved in the storage device as well as a variety of information can be displayed via the display module 200 through some prescribed manipulation process. As mentioned below, the cradle C according to the present invention can be used as an integrated multifunctional IT device, wherein the cradle C can receive prescribed data through external wire/wireless communication environments, display the data via the display module and communicate with the mobile communication device and the other peripheral device to display and reproduce the prescribed data saved in the corresponding devices.

Referring to FIG. 2, the internal configuration of the multifunctional cradle C in accordance with an embodiment of the invention is illustrated in a schematic block diagram.

As shown in the drawing, the base plate 100 includes the controller 120, a communication interface 130, a memory 140, an input port 150, an AV input/output port 160, an operation button 170, and a power supply which supplies power to the cradle C of the invention from an external power source or internal battery not shown in the drawing. It would be easily understood by those skilled in the art that a power adapter can be additionally provided when the external power source is used.

The controller 120 is designed to control whole operations of the cradle C of the invention as described below, plays a role of displaying the received data from outside via the display module 200, and can be constructed with a control circuit, such as a CPU (Central Processing Unit) and PCB (Printed Circuit Board), according to exemplary embodiments. However, it would be cautious that the controller 120 is not limited to a specific embodiment type if the controller can control/handle the operations of the cradle C of the invention by playing the role as described below.

The communication interface 130 is provided to communicate with external wire/wireless communication environments, which can include a wire/wireless LAN (Local Area Network), WIBRO (Wireless Broadband), WIMAX, 3G communication environments, and the like. As shown in the drawing, a manufacturer or a mobile communication service provider can transfer product information related to a variety of mobile communication devices on sale to retail stores via wire/wireless communication networks.

The cradle C of the invention receives the data through the communication interface 130 which can communicate by connecting with the wire/wireless communication environments via the communications protocol.

The controller 120 displays the data received via the communication interface 130 on the display module 200 as well as saving the received data into the memory 140. Therefore, each retail store can conveniently provide the product information related to the mobile communication devices to users without any inconvenient jobs of printing out the product information related to the mobile communication device and placing it on the cradle. Besides, the manufacturer or the mobile communication service provider can considerably save the inconvenient jobs by simply transferring the product information related to the mobile communication device to the retail stores, through the wire/wireless communication networks, needless to provide the product information related to the mobile communication device to the respective retail stores whenever a new mobile communication device is developed.

The advantage may not be big when only one retail store is targeted. As described with reference to the related art, there are more than tens of thousands of retail stores for mobile communication devices in the market, and lots of time and efforts are actually needed for the manufacturers to provide the product information to the retail stores and also for the retail stores to print out the product information and to display the printouts next to the matching mobile communication devices. Accordingly, the advantages of the present invention, which can reduce such time and efforts, need to be highlighted.

Furthermore, a mobile communication device and related information should be displayed by matching each other exactly according to the prior art. When the cradle C of the present invention is used, however, various kinds of product information related to the mobile communication device can be received via the wire/wireless communication and can be continuously displayed via the display module 200. As a result, each retail store can provide the information related to the mobile communication device to the customers by simply mounting the mobile communication device on the cradle, and annoying jobs of displaying by matching the product information to the mobile communication can be clearly removed.

On the other hand, the manufacturer or the mobile communication service provider can conveniently present a variety of advertisements via the cradle C of the present invention. There were disadvantages of preparing for the separate advertisement papers and displaying them in each retail stores since the conventional plastic cradle of the prior art has only one function of mounting the mobile communication device.

However, when the cradle C of the present invention is used, the manufacturer can provide more multiplied information to the users since the manufacturer's advertisement messages, the product related announcements, and data on the a variety of multimedia services as well as product information about new mobile communication device on sale can be displayed via the cradle C of the present invention by simply transferring them to the retail stores.

Further, according to an embodiment of the present invention, the AV input/output port 160 is provided to the cradle. Accordingly, when a separate display device equipped in the store, such as a large PDP (Plasma Display Panel) or LCD (Liquid Crystal Display) is connected to the output port of the AV input/output port, the above mentioned data can be displayed on the separate display device as well as the display module 200 under control of the controller 120. Consequently, each retail store can perform more efficient advertisements and business activities since each retail store can provide information on its main items and special advertisements to its customers via the large display device as well as the cradle of the present invention.

Meanwhile, the memory 140 saves both a software program needed to operate the cradle C of the present invention and another software program communicating with and operating the peripheral devices as described below. The memory 140 can be implemented with an HDD (Hard Disk Drive), RAM (Random-Access Memory), or a flash memory according to exemplary embodiments, even though its shape is not especially limited.

According to the exemplary embodiment of the present invention, the cradle C of the present invention also provides a function of showing and reproducing the data by connecting with various kinds of peripheral devices as well as the data received from the external communication environments in accordance with the user's manipulation. As shown in FIG. 2, the input port (preferably, a USB port) 150 and the AV input/output port 160 are additionally provided to the base plate 100 according to the embodiment of the present invention.

The input port 150 is to communicate with an external portable storage device 300. When the storage device 300, such as a USB memory card and a portable HDD, is connected with the input port 150, the computer accessible files saved in the corresponding storage device can be displayed and reproduced via the display module 200. The AV input/output port 160 is provided to connect an external. AV device 400 with the cradle C of the present invention. For example, when the external AV device 400, such as MP3 (MPEG Audio Layer 3) and PMP (Portable Media Player), is connected with the AV input/output port 160, various files saved in the corresponding device can be displayed and reproduced via the display module 200. According to the embodiment of the present invention, the AV input/output port 160 can include an HDMI (High-Definition Multimedia Interface) or DVI (Digital Video Interactive) port. Accordingly, when an external AV device is connected to the input port of the AV input/output port 160 and the previously described separate display device (for example, PDP, LCD and the like) is connected with the output port of the AV input/output port 160, a variety of media files can be displayed/reproduced via the separate display device connected with the AV output port as well as the display module 200 under control of the controller 120. As a result, amusement provided by the media files can be maximized according to the circumstances.

Describing in more detail, according to an embodiment, the display module 200 can be constructed as a touch screen type. The controller 120 is constructed to search at least one of the portable storage device 300 and the external AV device 400 connected with the input port 150 and the AV input/output port 160, thereby displaying/reproducing the computer accessible files saved in the device via the display module 200, in response to a user input signal on the touch screen.

Like this, the cradle of the present invention is constructed not only being used for simply displaying the mobile communication device in the retail stores, but being used by connecting with a variety of external device in various ways by the normal users.

To be more specific, as the storage volume has been increased, the storage volume of the portable USB memory has been growing bigger and the portable HDD has generally been used. However, these external storage devices can be used only when they are connected with the computer.

Regarding this, the cradle C of the present invention already includes the display module 200 and can easily utilize a variety of files saved in the external storage devices when the external storage devices are connected with the cradle C of the present invention. Consequently, the user can search and utilize various files saved in the devices by simply connecting with the cradle C of the present invention instead of connecting with the computer in order to use the external storage device 300 or the external AV device 400 more variously.

When the user inputs a prescribed input signal (for example, a normal computing operation such as searching the external storage device and selecting a specific file) via a designated screen (for example, file browser) on the touch screen after connecting the external storage device 300 and the external AV device 400 with the input port 150 and the AV input/output port 160, respectively, the controller 120 finds a saved file or selects a specific file by searching the external storage device or the external AV device in response to the input signal and then displays corresponding information via the display module 200. As it would be easily understood by those skilled in the art, the software program to perform the above mentioned function can be saved in the memory 140 and the detailed explanation and concrete description on the program and the motions of the controller will be omitted since the program to perform those functions is already well-known.

As an alternative, as shown in FIGS. 1 and 2, there is provided with at least one operation button 170 on the base plate 100 in order to select and execute the prescribed file by operating the portable storage device 300 and the external AV device 400 connected to the input port 150 and the AV I/O port 160. Unlike the above mentioned embodiment which performs the designated operation associated with an external device by constructing the display module 200 as the touch screen style, this embodiment provides the simple operation button 170, controlled by the controller 120, on the base plate such that the user can operate the external device with the button. Since the display module 200 does not need to be embodied as the touch screen style according to this embodiment, the expense related to the display module can be reduced. Since the operation of selecting/executing the file saved in the external device using the operation button 170 is the same as the touch screen style, the description will be omitted. Meanwhile, the operation button 170 can be embodied as, but not especially limited to, a simple button type or an input unit such as a ball mouse.

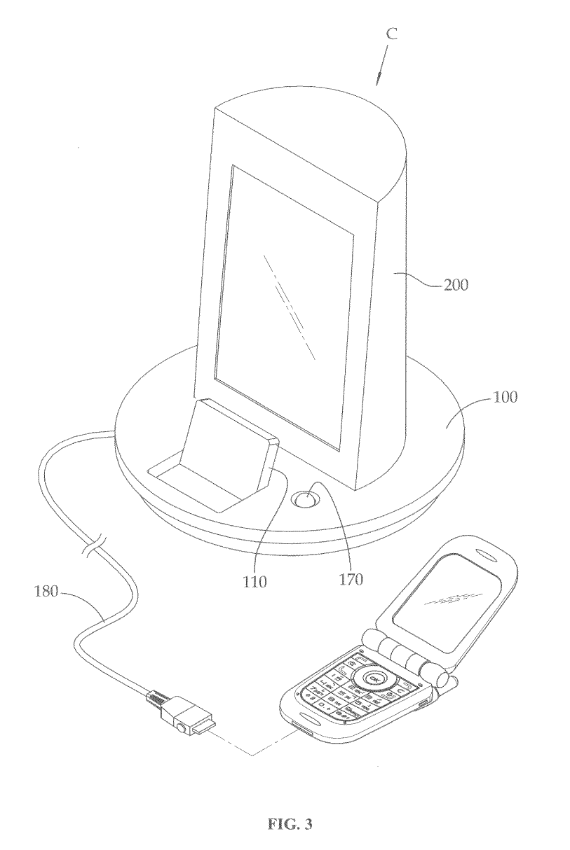

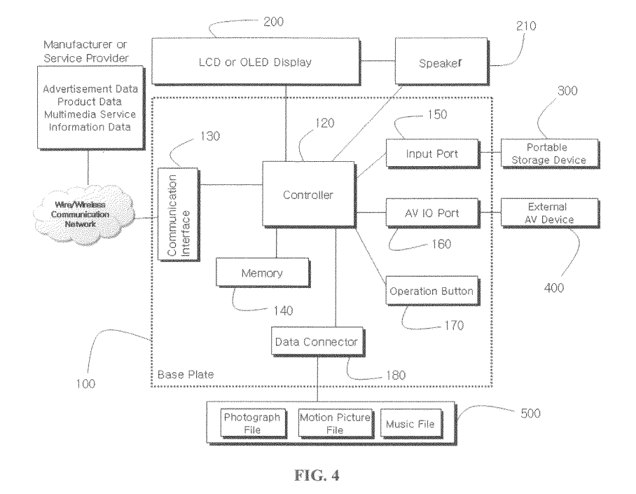

Hereinafter, yet another embodiment will be described with reference to FIGS. 3 and 4. In FIGS. 3 and 4, the same reference numerals are used to designate the same components as in FIGS. 1 and 2, and the duplicated description is omitted.

As shown in the drawings, a data connector 180 is additionally provided to the base plate 100 according to this embodiment unlike the embodiment of FIG. 2.

The data connector 180 is provided to communicate by wire with the mobile communication device to be mounted on the mounting part 110. The data connector 180 is connected with a connector port, which is normally provided in a mobile communication device.

In addition to a simple telephone call, additional functions of taking/reproducing photographs and motion pictures and playing music with MP3 files have been provided in the mobile communication device these days. Although these functions can be used on the mobile communication device, it is recently often that the mobile communication device is connected to a computer and then a variety of media files saved in the mobile communication device are utilized with the computer.

However, this type of utilization of the media files needs to be connected to the computer like the above mentioned external device and is inconvenient to perform.

Referring to the exemplary embodiment as illustrated in FIG. 3, the data connector 180 is provided on the base plate such that the user can use various media files in the mobile communication device which is connected with the connector. Instead of simply manipulating the mobile communication device and utilizing a variety of media files, such as photographs, motion pictures and music files, which are saved in the mobile communication device, the mobile communication device can be connected with the cradle C of the present invention via the data connector 180. Then, the user can utilize a variety of media files saved in the mobile communication device via the display module 200 since the mobile communication device and the cradle C are connected by data communication under control of the controller 110.

Although it is not illustrated in detail in the drawings, when the mobile communication device is connected with the cradle C of the present invention, the screen of the mobile communication device is displayed via the display module and the user can manipulate the mobile communication device using an input unit such as a keypad provided on the mobile communication device. The controller 110 displays and reproduces a variety of media files saved in the mobile communication device via the display module 200 according to the input signal through the input unit of the mobile communication device. Amusement from media files can be enhanced since the user can utilize a variety of media files on a bigger display screen by using the cradle C of the present invention instead of watching the photograph and the motion picture files on the small display screen of the mobile communication device. As it is easily understood by those skilled in the art, a variety of media files in the mobile communication device can be manipulated by using the input unit such as the previously described touch screen type and the operation button instead of using the keypad of the mobile communication device.

The user can enlarge the amusement by reproducing sound included in the media file when a variety of media files are used with the cradle C of the present invention. According to an embodiment of the present invention, an output device such as a speaker 210 can be additionally provided to the display module 200.

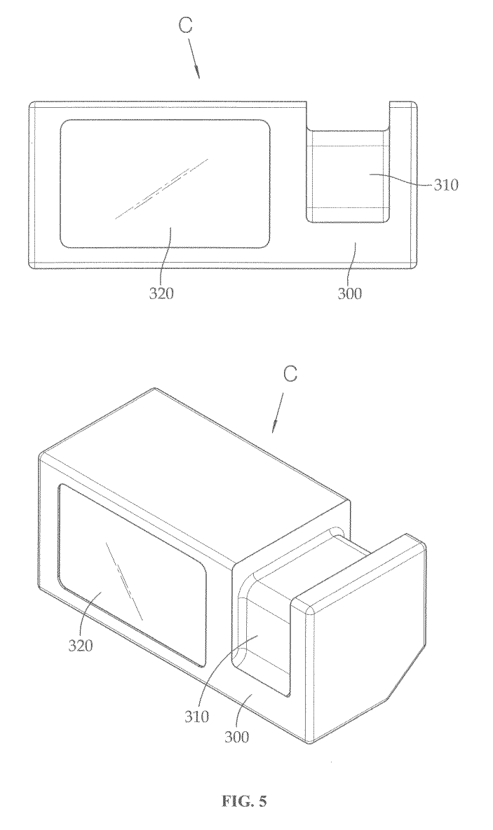

A perspective view of the multifunctional cradle C for mobile communication device according to yet another exemplary embodiment of the present invention is briefly illustrated in FIG. 5.

Only the outer shape of the cradle illustrated in FIG. 5 is different from the cradle illustrated in FIGS. 1 and 3. The described constructions and the operations with reference to FIGS. 1 to 4 are completely applied to the cradle illustrated in FIG. 5 and the repeated description will be omitted.

The cradle illustrated in FIG. 5 has a different outer shape from that of the cradle illustrated in FIGS. 1 and 3. The cradle in FIG. 5 is provided with the display module 320 on one side of a cradle body 300 structured as a polyhedron (it is a rectangular parallelepiped in this exemplary embodiment, but the present invention is not limited to this shape), a mounting part 310 is provided to a part of the cradle body 300, which has an receiving portion for receiving the mobile communication device. According to this structure, there is an advantage of providing all the information to the user via the display module since the display module 320 is not hided by the mobile communication device. Varieties of components provided with the cradle illustrated in FIGS. 1 to 4 are provided inside the body to perform the previously described functions. Although not illustrated in FIG. 5 in detail, the data connector can be provided, which can communicate by data with the mobile communication device and charge the mobile communication device.

While the present invention has been described with reference to the certain exemplary embodiments thereof, the present invention is not limited to the described embodiments and can be changed and corrected into various forms without departing from the spirit and scope of the invention as defined by the following appended claims. For example, although the input port and the AV input/output port are described as being formed on the base plate in the exemplary embodiments, these can be provided to the display module to perform the previously described functions. The speaker also can be formed on the base plate instead of the display module or on both the base plate and the display module. Furthermore, the outer shape of the cradle of the present invention is not especially limited as previously described and the outer shape of the cradle illustrated in the drawings can be changed in various forms. These kinds of modified forms are also included in the scope of the present invention, which can be defined by only the appended claims and their equivalents.

What is claimed is:

1. A multifunctional cradle for a mobile communication device, to be provided and used in a store, the cradle comprising:
a base plate having a mounting part provided on a surface thereof to mount and support the mobile communication device; and
a display module installed uprightly on the base plate and configured to communicate data with the base plate;
wherein the base plate comprises therein a communication interface for allowing data communication with a server of a mobile communication device manufacturer or a mobile communication service provider through a wire/wireless communication network; a memory; and a controller for controlling whole operation of the cradle,
wherein the controller is constructed to receive predetermined data from the server via the communication interface, to store the predetermined data in the memory and to output the predetermined data via the display module, the predetermined data including at least one selected from the group consisting of product information data, advertisement data that the mobile communication device manufacturer or the mobile communication service provider wants to deliver and a variety of multimedia service related data.

2. The multifunctional cradle according to claim 1, wherein at least one of the base plate and the display module has at least one of an input port for communicating with an external portable storage device and an AV input/output port for communicating with an external AV device.

3. The multifunctional cradle according to claim 2, wherein the display module comprises a touch screen, and the controller is constructed to search at least one of the portable storage device connected with the input port and the external AV device connected with the AV input/output port and to display/reproduce a computer accessible file saved in the device via the display module in response to a user input signal on the touch screen.

4. The multifunctional cradle according to claim 2, further comprising an input unit provided on the base plate,
wherein the controller is constructed to search at least one of the external portable storage device and the AV device connected with the AV input/output port, and display/reproduce a computer accessible file saved in the device via the display module in response to a user input signal through the input unit.

5. The multifunctional cradle according to claim 1, further comprising a data connector provided on the base plate, the data connector allowing data communication with the mobile communication device by wire under control of the controller.

6. The multifunctional cradle according to claim 5, wherein the controller is constructed to display and reproduce a variety of media files, saved in the mobile communication device, on the display module in response to an input signal received from the mobile communication device connected with the data connector.

7. The multifunctional cradle according to claim 3, further comprising a sound output device provided on the base plate.

8. The multifunctional cradle according to claim 1, wherein the wire/wireless communication network includes a wire/wireless LAN (Local Area Network), a WIBRO (Wireless Broadband) network, a WiMAX (Worldwide Interoperability for Microwave Access) network and a 3 G communication network.

9. The multifunctional cradle according to claim 1, wherein the memory has a software program saved therein, which allows operating of the cradle and performing data communication with an external device connected with the cradle in order to operate the external device.

10. A multifunctional cradle for a mobile communication device, comprising:
a cradle body having a polyhedral structure;
a display module provided on one side of the body to display data received from a server of a mobile communication device manufacturer or a mobile communication service provider; and
a mounting part provided to a part of the cradle body and having a receiving portion for receiving the mobile communication device;
wherein the cradle body is provided therein with a communication interface for allowing data communication with the server through a wire/wireless communication network; a memory; and a controller for controlling whole operation of the cradle,
wherein the controller is constructed to receive predetermined data from the server via the communication interface, to store the predetermined data in the memory and to output the predetermined data via the display module, the predetermined data including at least one selected from the group consisting of product information data, advertisement data that the mobile communication device manufacturer or the mobile communication service provider wants to deliver and a variety of multimedia service related data.

11. The multifunctional cradle according to claim 10, wherein the cradle body has at least one of an input port for communicating with an external storage device and an AV input/output port for communicating with an external AV device.

12. The multifunctional cradle according to claim 11, wherein the input port is a USB port.

13. The multifunctional cradle according to claim 11, wherein the AV input/output port is an HDMI or DVI port.

14. The multifunctional cradle according to claim 11, wherein the display module comprises a touch screen, and the controller is constructed to search at least one of the portable storage device connected with the input port and the external AV device connected with the AV input/output port and to display/reproduce a computer accessible file saved in the device via the display module, in response to a user input signal on the touch screen.

15. The multifunctional cradle according to claim 11, further comprising an input unit provided to the cradle body,
wherein the controller is constructed to search at least one of the external portable storage device connected with the input port and the AV device connected with the AV input/output port, and display/reproduce a computer accessible file saved in the device via the display module, in response to a user input signal through the input unit.

16. The multifunctional cradle according to claim 10, further comprising a data connector provided to the cradle body, the data connector allowing data communication with the mobile communication device by wire under control of the controller.

17. The multifunctional cradle according to claim 16, wherein the controller is constructed to display and reproduce a variety of media files, saved in the mobile communication device, on the display module, in response to an input signal received from the mobile communication device connected with the data connector.

18. The multifunctional cradle according to claim 16, further comprising a sound output device provided to the cradle body.

19. The multifunctional cradle according to claim 10, wherein the wire/wireless communication network includes a wire/wireless LAN (Local Area Network), a WIBRO (Wireless Broadband) network, a WiMAX (Worldwide Interoperability for Microwave Access) network and a 3G communication network.

20. The multifunctional cradle according to claim 10, the memory has a software program saved therein, which allows operating of the cradle and performing of data communication with an external device connected with the cradle in order to operate the external device.
